(19) United States
(12) Patent Application Publication
(10) Pub. No.: US 2006/0224260 A1
(43) Pub. Date: Oct. 5, 2006

(54) Scan shuffle for building playlists

(76) Inventors: Wendell T. Hicken, La Verne, CA (US); Marc E. Campbell, Monrovia, CA (US)

Correspondence Address: CHRISTIE, PARKER & HALE, LLP, PO BOX 7068, PASADENA, CA, 91109-7068, US

(21) Appl. No.: 11/369,609

(22) Filed: Mar. 6, 2006

Related U.S. Application Data
(60) Provisional application No. 60/658,739, filed on Mar. 4, 2005.
(60) Provisional application No. 60/737,533, filed on Nov. 15, 2005.

(51) Int. Cl. G06F 17/00

(52) U.S. Cl. 700/94

(57) ABSTRACT

A scan shuffle mechanism for building playlists. A user selects a scan shuffle button to cause the user's music collection to be sorted acoustically and scanned in the acoustically sorted order. Small segments of the sorted songs are played one by one until the user hears a desired song. The user selects the scan shuffle button again to set the currently played song as a seed song that generates a playlist of complementing songs.

### CROSS-REFERENCE TO RELATED APPLICATION(S)

This application claims the benefit of Provisional Application No. 60/658,739, filed on Mar. 4, 2005, and further claims the benefit of Provisional Application No. 60/737,533, filed on Nov. 15, 2005, the content of both of which are incorporated herein by reference. This application is also a continuation-in-part of U.S. application Ser. No. 10/917,865, filed on Aug. 13, 2004 (attorney docket 52075), a continuation-in-part of U.S. application Ser. No. 10/668,926, filed on Sep. 23, 2003 (attorney docket 50659), a continuation-in-part of Ser. No. 10/278,636, filed on Oct. 23, 2002 (attorney docket 48763), and a continuation-in-part of U.S. application Ser. No. 11/236,274, filed on Sep. 26, 2005 (attorney docket 56161), which in turn is a continuation of U.S. application Ser. No. 09/556,051, now abandoned, filed on Apr. 21, 2000 (attorney docket 37273), the content of all of which are incorporated herein by reference.

### BACKGROUND OF THE INVENTION

The above-referenced U.S. application Ser. No. 10/917,865, discloses a system and method that generates a playlist of songs that complement a manually selected seed song, artist, or album (collectively referred to as seed music). The application entitled “Music Searching System and Method,” filed on even date herewith, discloses a system and method for selecting a seed song, artist, or album, by conducting a metadata search of a key term manually entered by the user. The seed song may then be used to generate a playlist of complementing songs.

Other prior art systems similarly require some kind of manual identification from the user in order to build a playlist, such as, for example, a particular genre or category of songs.

There are situations, however, where the user may want to listen to music, but not really know what kind of music he or she is in the mood for. With radio, the user may surf the different radio stations in search of music that he or she likes. With a music player such as, for example, an ipod, the user may make a random shuffle of all the music he or she owns, and listen to the randomly shuffled music. In either situation, however, it may take a long time before the user stumbles across music that he or she will enjoy.

Even if the user knows exactly what he or she is in the mood for, specifically entering a search term or selecting seed music from a list may not be possible for devices that are not equipped with a display or key word entry mechanism. Even if equipped with a display or key word entry mechanism, it may not be practical to do so (e.g. the user is driving) or not possible (e.g. the user is blind).

Accordingly, what is desired is a mechanism that allows the user to sample as many diverse types of music as possible in a short amount of time, and allows the user to create a playlist based on a sampled music without requiring elaborate input from the user.

### SUMMARY OF THE INVENTION

The present invention is directed to a music player with a scan shuffle mechanism for building playlists. The music player includes a user input, an output, a processor coupled to the user input and output, and a memory operably coupled to the processor. The memory stores program instructions for execution by the processor. The program instructions include automatically scanning through a plurality of music pieces in a music collection and playing a sample of each scanned music piece, and detecting actuation of the user input while the sample of the music piece is being played. The actuation of the user input indicates a selection of the music piece. Responsive to the actuation of the user input, a playlist is generated which includes other music pieces acoustically complementing the selected music piece. The playlist is then output via the output device.

According to one embodiment, the plurality of music pieces are acoustically sorted prior to scanning and playing the sample of each scanned music piece. The acoustically sorting includes ordering at least a portion of the music pieces so that acoustic vectors of two adjacent music pieces in the list are at least a threshold distance apart.

According to one embodiment, each acoustic vector provides numerical measurements for a plurality of predetermined acoustic attributes based on an automatic processing of audio signals for the associated music piece.

According to one embodiment, the playlist is generated by retrieving first acoustic analysis data associated with the selected music piece; retrieving second acoustic analysis data associated with a candidate music piece; comparing the first acoustic analysis data with the second acoustic analysis data; and selecting the candidate music piece for including into the playlist based on the comparison.

According to one embodiment of the invention, the sample of the scanned music piece is X seconds of the music piece starting from Y seconds into the music piece, wherein X and Y are real numbers greater than 0.

According to one embodiment of the invention, the automatic scanning of the music pieces is invoked in response to computer program instructions detecting second user actuation of the user input.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a block diagram of a music player according to one embodiment of the invention;

FIG. 2 is a front view of an exemplary music player according to one embodiment of the invention;

FIG. 3 is a flow diagram of a process for building a playlist based on a scan shuffle selection according to one embodiment of the invention; and

FIG. 4 is a more detailed flow diagram of a process of generating a list of acoustically sorted songs according to one embodiment of the invention.

### DETAILED DESCRIPTION

In general terms, the present invention is directed to a scan shuffle mechanism for building playlists. The scan shuffle mechanism allows a user to scan through the user's music collection by selecting a scan shuffle button. The scan shuffle button sorts the user's music collection acoustically so that the user will get the broadest possible exposure to his collection in the shortest amount of time.

While the songs in the collection are scanned, small segments of each song are played one by one until the user hears a desired song. According to one embodiment of the invention, the songs are sorted acoustically before they are scanned so that a next song that is played will be acoustically different from a song that was previously played. When the user hears a song that he or she likes, the user selects the scan shuffle button again to select the song as a seed song and generate a playlist of complementing songs based on the selected seed song.

According to one embodiment of the invention, the scan shuffle is based on music owned by the user. Alternatively, the scan shuffle mechanism may be incorporated into a remote server for allowing a user of an end-user device to scan music stored at the remote server. A playlist generated based on the scan shuffle may then be streamed to the end-user device for listening by the user.

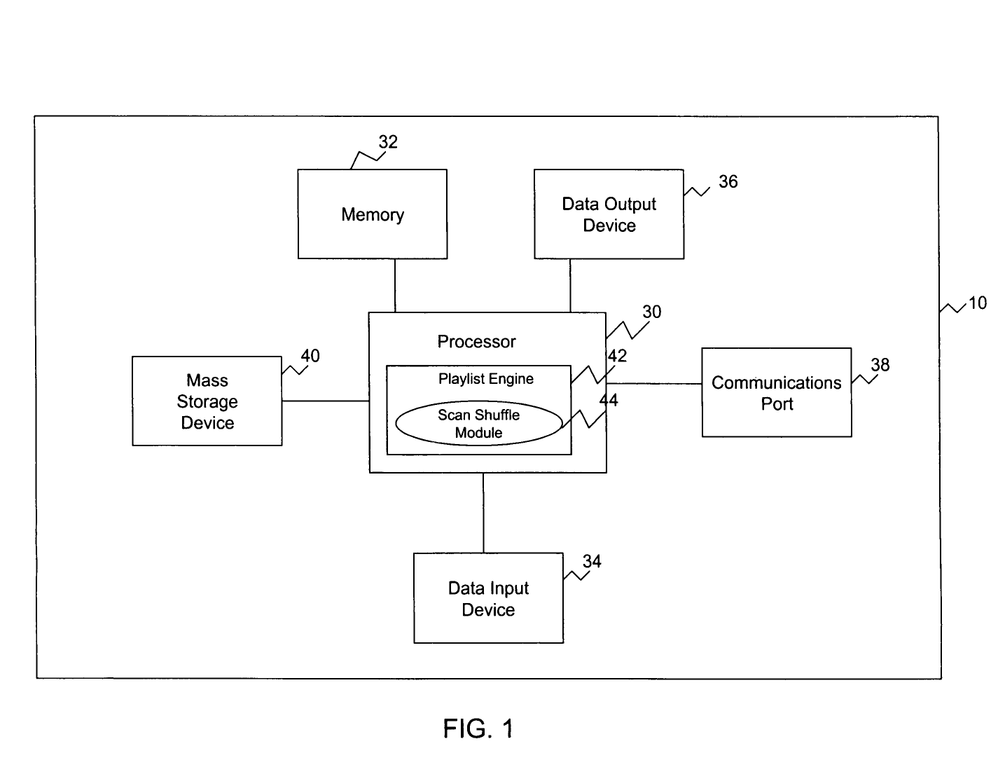

FIG. 1 is a block diagram of a music player supporting the scan shuffle mechanism according to one embodiment of the invention. The music player may be a personal computer, personal digital assistant (PDA), entertainment manager (e.g. iPod), car player, home player, portable player, portable phone, or any consumer electronics device capable of playing music known in the art. The music player 10 includes a processor 30, memory 32, data input device 34, data output device 36, communications port 38, and mass storage device 40.

The data input device 34 may take the form of a keyboard, keypad, control button, stylus, microphone, remote controller, and/or the like, for allowing a user to enter user input data. According to one embodiment of the invention, the data input device includes a scan shuffle control button which may be selected to scan the user's music collection and generate a playlist based on the selection of a currently scanned song.

The data output device 36 may include an optional display screen for displaying text and/or graphics, speakers for outputting audio sounds, and/or the like. Pressure sensitive (touch screen) technology may also be incorporated into the any incorporated display screen for allowing a user to provide additional data input by merely touching different portions of the display screen.

The communications port 38 allows the exchange of data between the music player and one or more other computer devices (not shown) in a wired or wireless manner. For example, the data communications port may be used to receive and/or transmit songs, acoustic analysis data, profile data, and/or lyric analysis data from and/or to the computer devices. In some embodiments, the communications port 38 may take the form of a local or wide area network port for accessing one or more servers (not shown) over a local or wide area network.

The memory 32 may include a read only memory, random access memory, flash memory, and the like. According to one embodiment, the memory stores playlist engine instructions (referred to as a playlist engine 42) which are loaded and executed by the processor 30 for generating and transmitting and/or playing a playlist of songs. The playlist engine 42 includes scan shuffle instructions (referred to as a scan shuffle module 44) for sorting the user's music collection acoustically and playing small segments of the sorted music, and further detecting a user selection of a scanned song for causing the playlist engine 42 to generate a playlist based on the scanned song.

The mass storage device 40 may include a static random access memory device, hard disk, and/or the like. According to one embodiment of the invention, the mass storage device 40 stores the user's music collection, metadata information for the songs in the user's music collection, song lyrics, and the like. The metadata information may include, for example, title, album, artist information, and/or a link to the server for downloading the song and/or purchasing an album containing the song.

The mass storage device 40 may also store acoustic analysis data, profile data, and/or lyric analysis data for the music in the user's music collection. Such data may be generated by the music player itself, or downloaded from a central database as is described in further detail in the above-referenced U.S. application Ser. No. 10/917,865.

In generating the acoustic analysis data, a generating device engages in automatic analysis of the audio signals of the song to be analyzed via an audio content analysis module. The audio content analysis module takes the audio signals and determines its acoustic properties/attributes, such as, for example, tempo, repeating sections in the audio piece, energy level, presence of particular instruments (e.g. snares and kick drums), rhythm, bass patterns, harmony, particular music classes (e.g. jazz piano trio), and the like. The audio content analysis module computes objective values of these acoustic properties as described in more detail in U.S. patent application Ser. Nos. 10/278,636 and 10/668,926. As the value of each acoustic property is computed, it is stored into an acoustic attribute vector as the audio description or acoustic analysis data for the audio piece. The acoustic attribute vector thus maps calculated values to their corresponding acoustic attributes.

The profile data relates to an acoustic profile for a group of audio pieces, such as the audio pieces in a playlist, in an album, or associated with a particular artist. The profile data may be represented as a group profile vector storing coefficient values for each of the attributes in an acoustic attribute vector. According to one embodiment of the invention, a group profile vector is generated based on analysis of the individual acoustic attribute vectors of the songs belonging to the group, as is described in further detail in U.S. application Ser. Nos. 10/278,636 and 10/917,865. The coefficient values in a group profile vector help determine the most distinct and unique attributes of a set of songs with respect to a larger group.

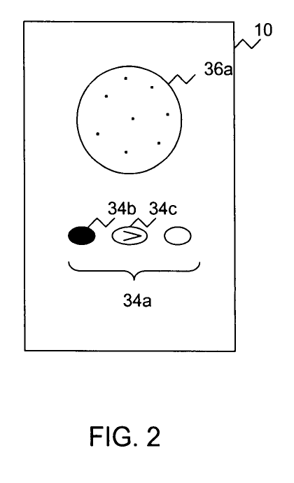

FIG. 2 is a front view of an exemplary music player 10 according to one embodiment of the invention. The player 10 at a minimum includes input buttons 34a and a speaker 36a. Included as part of the buttons is a shuffle control button 34b for invoking the scan shuffle function. According to one embodiment of the invention, the scan shuffle control button 34b is distinctly marked and/or provides a distinct tactile feel for identifying it as the scan shuffle control button. A single selection of the scan shuffle control button 34b causes it to automatically output, via the speaker 36a, small segments of different types of songs in the user's collection. While the songs are being scanned, if the user does not want to hear the full sample of a particular song, he or she may skip to a next song by selecting a next button 34c.

When the user hears a particular scanned music that he or she likes, the user selects the scan shuffle control button 34b a second time, causing that music that was being played to be used as seed music for generating a playlist of music that acoustically complements the seed music. The playlist is invoked once the selected seed music finishes playing.

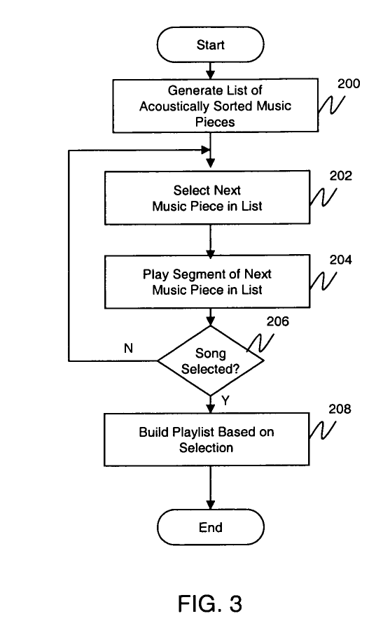

FIG. 3 is a flow diagram of a process for building a playlist based on a scan shuffle selection according to one embodiment of the invention. The process is invoked upon an initial user selection of the scan shuffle control button 34b. Voice commands may also be used in lieu or in addition to the scan shuffle control button to invoke the scan shuffle process.

In step 200, the scan shuffle module 42 analyzes the songs in the user's music collection as stored in the mass storage device 40 (or in a remote database), and generates a scan list of acoustically sorted songs (also referred to as a sampling set)

The scan shuffle module 44 then plays the songs in the generated sampling set in a scanning mode. In this regard, the scan shuffle module 44, in step 202, selects the next music piece in the list. If the end of the list has been reached, the module simply skips back to the start of the list for sampling the songs again.

In step 204, proceeds to play a segment of the selected music piece. In this regard, the module selects a particular portion of the song selected to sample, and plays that portion for a predetermined amount of time. For example, the module may play the song for 10 seconds starting from 30 seconds into the song. If the song is less than, for example, 50 seconds, the 10 second sample may be centered in the middle of the song.

According to another embodiment of the invention, the best part of the song to sample may be chosen algorithmically by analyzing the acoustic patterns of the song. Such an analysis may identify, for example, the “chorus” or “hook” of a piece, for allowing the “chorus” or “hook” to be played as the sample.

According to one embodiment of the invention, a user may press the “next” button 34c to move to a next song without listening to the entire sample period.

In embodiments where the music player 10 includes a visual element, the scan shuffle module 44 may optionally display album artwork and information about the current song being scanned to assist the user in his or her decision-making.

In step 206, a determination is a made as to whether the user has selected the currently scanned song. The user may make the selection, for example, by selecting the scan shuffle control button 34b a second time. If the answer is YES, the scan shuffle module 44 uses the selected song as the seed music, and proceeds to generate a playlist based on the seed music while the song continues playing without interruption until it ends (as opposed to just the end of the sample portion). According to another embodiment of the invention, the selected song starts playing from the beginning upon its selection. After the selected song is finished playing, the playlist engine 42 then proceeds to play the songs in the generated playlist.

According to one embodiment of the invention, the songs in the generated playlist are songs determined to complement the selected seed music. Such complementing songs are selected based on a comparison of acoustic analysis data of the complementing songs and the acoustic analysis data of the seed music as is described in further detail in U.S. application Ser. No. 10/917,865. The playlist may also be generated using any other algorithm for generating playlists, such as, for example, based on lyrics, social heuristics, metadata, and the like.

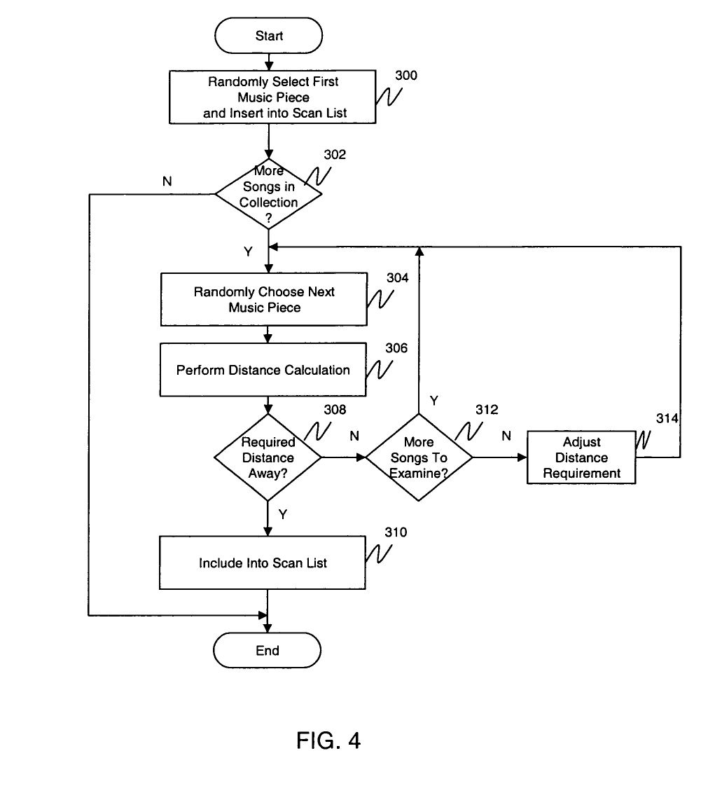

FIG. 4 is a more detailed flow diagram of the process of step 200 for generating a scan list of acoustically sorted music pieces according to one embodiment of the invention. In step 300, the scan shuffle module 44 randomly selects a first music piece from the user's music collection and inserts it into the scan list.

In step 302, a determination is made as to whether there are any more music pieces in the collection that need to be sorted. If the answer is YES, the engine proceeds to randomly choose another music piece in the collection in step 304, and further retrieves its acoustic analysis vector. As described in further detail in U.S. application Ser. No. 10/278,636, the acoustic analysis vector provides objective numerical measurements for a predetermined set of acoustic properties/attributes based on an automatic analysis of the audio signals of the music piece.

In step 306, the scan shuffle module 44 performs a distance calculation between the currently chosen music piece and one or more previously selected music pieces in the scan list for determining one or more acoustic distances. According to one embodiment of the invention, the distance calculation is a vector distance calculation based on the acoustic analysis vector of the chosen music piece and the acoustic analysis vector of a previously selected music piece. According to one embodiment of the invention, the scan shuffle module performs distance calculations between the currently chosen music piece and the last selected music piece, as well as between the currently chosen music piece and the selected music piece previous to the last selected music piece if such exists.

Based on the calculation in step 306, a determination is made in step 308 as to whether the currently chosen music piece is a required distance away from the previously selected music piece(s). Specifically, the module determines whether the current music piece is a threshold distance (X) away from the last selected music piece, and half that threshold distance (X/2) away from the selected music piece previous to the last selected music piece if such exists. If the answer is YES, the currently chosen music piece is selected and inserted as the next song into the scan list.

However, if the currently chosen music piece is not the required distance away from the previously selected music piece(s), a determination is made in step 312 as to whether there are any more remaining music pieces that need to be examined. If the answer is YES, the scan shuffle module 44 proceeds to analyze another music piece in the user's collection.

Otherwise, if all remaining music pieces have been analyzed without meeting the current distance requirement, the scan shuffle module 44 adjusts the distance requirement in step 314. This may be done, for example, by selecting a smaller X value. The scan shuffle module then runs the analysis on the remaining music pieces with the new distance requirement. If however, there are still music pieces remaining after the smallest possible value for X has been chosen that do not meet the distance requirement, the remaining music pieces are chosen randomly and included into the scan list.

Although this invention has been described in certain specific embodiments, those skilled in the art will have no difficulty devising variations to the described embodiment which in no way depart from the scope and spirit of the present invention. In addition, to those skilled in the various arts, the invention itself herein will suggest solutions to other tasks and adaptations for other applications. It is the Applicants' intention to cover all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

What is claimed is:

1. A method for building a playlist comprising:
automatically scanning through a plurality of music pieces in a music collection and playing a sample of each scanned music piece;
receiving a user input while the sample of the music piece is being played, the user input for indicating a selection of the music piece;
responsive to the received user input, generating a playlist including other music pieces acoustically complementing the selected music piece; and
outputting the playlist for the user.

2. The method of claim 1 further comprising:
acoustically sorting the plurality of music pieces prior to scanning and playing the sample of each scanned music piece.

3. The method of claim 2, wherein the acoustically sorting includes ordering at least a portion of the music pieces so that acoustic vectors of two adjacent music pieces in the list are at least a threshold distance apart.

4. The method of claim 3, wherein each acoustic vector provides numerical measurements for a plurality of predetermined acoustic attributes based on an automatic processing of audio signals for the associated music piece.

5. The method of claim 1, wherein the generating the playlist further includes:
retrieving first acoustic analysis data associated with the selected music piece;
retrieving second acoustic analysis data associated with a candidate music piece;
comparing the first acoustic analysis data with the second acoustic analysis data; and
selecting the candidate music piece for including into the playlist based on the comparison.

6. The method of claim 1, wherein the sample of the scanned music piece is X seconds of the music piece starting from Y seconds into the music piece, wherein X and Y are real numbers greater than 0.

7. The method of claim 1, wherein the automatic scanning is invoked in response to a second user input.

8. A music player comprising:
a user input;
an output;
a processor coupled to the user input and output; and
a memory operably coupled to the processor and storing program instructions therein, the processor being operable to execute the program instructions, the program instructions including:
automatically scanning through a plurality of music pieces in a music collection and playing a sample of each scanned music piece;
detecting actuation of the user input while the sample of the music piece is being played, the actuation for indicating a selection of the music piece;
responsive to the actuation of the user input, generating a playlist including other music pieces acoustically complementing the selected music piece; and
outputting the playlist via the output.

9. The music player of claim 8, wherein the program instructions further include:
acoustically sorting the plurality of music pieces prior to scanning and playing the sample of each scanned music piece.

10. The music player of claim 9, wherein the computer program instructions for acoustically sorting includes computer program instructions for ordering at least a portion of the music pieces so that acoustic vectors of two adjacent music pieces in the list are at least a threshold distance apart.

11. The music player of claim 10, wherein each acoustic vector provides numerical measurements for a plurality of predetermined acoustic attributes based on an automatic processing of audio signals for the associated music piece.

12. The music player of claim 8, wherein the computer program instructions for generating the playlist further includes computer program instructions for:
retrieving first acoustic analysis data associated with the selected music piece;
retrieving second acoustic analysis data associated with a candidate music piece;
comparing the first acoustic analysis data with the second acoustic analysis data; and
selecting the candidate music piece for including into the playlist based on the comparison.

13. The music player of claim 8, wherein the sample of the scanned music piece is X seconds of the music piece starting from Y seconds into the music piece, wherein X and Y are real numbers greater than 0.

14. The music player of claim 8, wherein the computer program instructions for automatically scanning is invoked in response to computer program instructions detecting second user actuation of the user input.

15. A music player comprising:
means for automatically scanning through a plurality of music pieces in a music collection and playing a sample of each scanned music piece;
means for receiving a user input while the sample of the music piece is being played, the user input for indicating a selection of the music piece;
means responsive to the received user input for generating a playlist including other music pieces acoustically complementing the selected music piece; and
means for outputting the playlist for the user.

16. The music player of claim 15 further comprising:
means for acoustically sorting the plurality of music pieces prior to scanning and playing the sample of each scanned music piece.

17. The music player of claim 16, wherein the means for acoustically sorting includes means for ordering at least a portion of the music pieces so that acoustic vectors of two adjacent music pieces in the list are at least a threshold distance apart.

18. The music player of claim 17, wherein each acoustic vector provides numerical measurements for a plurality of predetermined acoustic attributes based on an automatic processing of audio signals for the associated music piece.

19. The music player of claim 15, wherein the means for generating the playlist further includes:
means for retrieving first acoustic analysis data associated with the selected music piece;
means for retrieving second acoustic analysis data associated with a candidate music piece;
means for comparing the first acoustic analysis data with the second acoustic analysis data; and
means for selecting the candidate music piece for including into the playlist based on the comparison.

20. The music player of claim 15, wherein the sample of the scanned music piece is X seconds of the music piece starting from Y seconds into the music piece, wherein X and Y are real numbers greater than 0.

21. The music player of claim 15, wherein the means for automatic scanning is invoked in response to a second user input.
